(19) United States
(12) Patent Application Publication
(10) Pub. No.: US 2006/0170215 A1
(43) Pub. Date: Aug. 3, 2006

(54) Hose clamp

(76) Inventor: Martin Cousineau, Repentigny (CA)

Correspondence Address: Franz BONSANG;c/o PROTECTIONS EQUINOX INT'L INC., Suite 224, 4480, Cote-de-Liesse, Montreal, QC, H4N 2R1, CA

(21) Appl. No.: 11/374,146

(22) Filed: Mar. 14, 2006

Related U.S. Application Data
(63) Continuation-in-part of application No. 10/716,566, filed on Nov. 20, 2003, now abandoned.
(60) Provisional application No. 60/429,534, filed on Nov. 29, 2002.

(51) Int. Cl. F16L 25/00

(52) U.S. Cl. 285/420

(57) ABSTRACT

A heavy-duty clamp for a hose includes a loop, for disposing around the hose, which has two axially spaced apart looped ends. The clamp has a force generator which is connected to the two looped ends. The force generator has a bolt with a plurality of disc springs mounted thereon to allow substantially high and constant predetermined axial clamping force from the force generator under expansion and contraction of the hose over temperature operational condition of the clamp. A spacer member is mounted on the force generator between the disc spring and one of the looped ends for axially transferring the clamping force from the force generator to the looped ends. The clamping force axially draws together the looped ends so as to clamp the hose. The arrangement of the disc springs allows adjustment of the maximal allowable axial clamping force rating of the clamp.

### CROSS REFERENCE TO RELATED APPLICATIONS

This application is a Continuation-In-Part (C.I.P.) of patent application Ser. No. 10/716,566, filed on Nov. 20, 2003, now abandoned.

### FIELD OF THE INVENTION

The present invention concerns clamps, more particularly to clamps for use with hoses.

### BACKGROUND OF THE INVENTION

Hose clamps are well known and widely used in industry and are practical and reliable in applications requiring large controllable holding force. Conventionally, hose clamps include a loop of resilient material such as stainless steel, steel or plastic, which loops around the outside wall of a hose and applies a clamping force thereto. However, there exist applications where it is desirable to apply and maintain constant torque forces against the hose clamp so as to retain high clamping forces during expansion and contraction of the hose during extremes of temperature and pressure. Such temperature and pressure fluctuations are typical for hoses used on, for example, automobile exhaust systems. In addition, mechanical stresses such as vibrations and dynamic stresses, normally encountered during operation of the automobile engine, are sufficient to dislodge hose clamps that are not clamped by sufficiently strong clamping forces.

A number of designs for hose clamps exist, including:
U.S. Pat. No. 4,819,307, issued Apr. 11, 1991 to Turner for “Hose Clamp”;
U.S. Pat. No. 5,010,626, issued Apr. 30, 1991 to Dominguez for “Hose Clamp with Flanged Captive Tensioning Nut and Pivoted Bridge Element”;
U.S. Pat. No. 5,299,344, issued Apr. 5, 1994 to Oetiker for “Reinforcing Arrangement for Open Hose Clamps, Especially Screw-Type Hose Clamps”;
U.S. Pat. No. 5,720,086, issued Feb. 24, 1998 to Eliasson et al. for “Clamping Collar”; and
WO 01/27516A1, published Apr. 19, 2001 to Dominguez for “Improved Clamp with a Tightening Screw”.

These hose clamps, however, suffer from a number of important disadvantages. Most clamps use a bolt that applies a clamping force directly against a shoulder of a loop end. During application of high torque forces during the clamping operation, the force direction may not be axially applied in a constant manner due to deformation of the shoulder by the clamping forces. This non-constant application of torque force across the loop end may be prone to failure during temperature related expansion and contraction of the hose.

Disadvantageously, most hose clamp designs use T-bolts and coil springs made of steel, which is prone to corrosion and freezing under normal hot/cold and humid operation conditions, thus decreasing the clamping torque of the clamp over time and severely limiting the life cycle thereof. In addition, most coil springs limit the amount of force that can be applied during clamping, especially when corrosion resistant spring material is used such as stainless steel. For example, the maximum applicable torque load over an existing enlarge coil spring clamp of a specific hose diameter, such as the clamp part No. BRZ-B9226-0406 from Breeze Industrial Products Corporation™, is about 100 in-lbs (at full compression of the coil spring) to hold a maximum internal hose pressure of about 55-60 psi (pound per square inch) and 160 in-lbs at failure (physical breakage of the clamp); as depicted by curve 90 of FIG. 12. In order to sustain much higher hose internal pressure up to and above 100 psi by increasing this maximum workable torque load up to and above 150 in-lbs, or the maximal load rating of the clamp, the coil spring would need to be of an outer diameter of about three times (3×) than that of an equivalent loading capacity disc spring, such as about at least two inches (2 in), which could be as large as the hose itself and would therefore prove unpractical and unusable.

Other types of clamps use disc springs made of stainless steel or tungsten alloys to improve the load constancy over temperature induced deflection, irrespective of any maximal load and corrosion considerations. Other types of hose clamps use worm gears to apply torque forces to the clamp, which worm gears may be unsuitable in operations requiring constant high clamping torque. In some cases, to avoid damage or rupture of the clamp during operation, it would be advisable to have a better control the constancy of the clamping torque over operational conditions of the clamp.

Thus there is a need for an improved heavy-duty hose clamp that can be used to apply and maintain substantially constant high clamping forces over operational life conditions thereof.

### SUMMARY OF THE INVENTION

The present invention is directed towards a solution to the aforesaid problems by providing a heavy-duty hose clamp with a novel spacer that allows a user to axially apply constant significant torque forces during a clamping operation, especially because of the curved portions of the bolt head and nut freely pivotally engaging respective looped ends of the loop or band. A novel combination of the spacer, capture nuts and an arrangement of a number of axially aligned disc springs maintain constant high clamping forces around the hose. The capture nuts are shaped to allow inward transfer of the clamping forces from a bolt to looped ends to close the gap therebetween and to reduce the clamp loop around the hose. Advantageously, the clamp significantly increases the magnitude of working clamping torque that is safely available to the user, easily up to about 420 in-lbs, and the adjustment thereof, depending on the disc arrangement as well as the geometrical configuration of the disc. The hose clamp of the present invention, especially because of the use of disc springs, is simple to operate and is manufactured from inexpensive, lightweight and readily available corrosion resistant materials, such as stainless steel or the like. The hose clamp can be custom made to fit many hose dimensions, up to about 35 inches in diameter, and uses readily available tools to apply the clamping forces to the bolt. In addition, the user can select many combinations of the disc springs' orientation and quantity to apply a variety of different clamping deflections for the clamping operation required. Also, varying the quantity of disc springs allow to control of the amount of displacement between the two looped ends for a substantially constant clamping torque over the amount of hose circumferential variation (contraction/expansion). Varying the physical characteristics of the disc springs such as the disc thickness allows determining the maximum clamping torque capability of the hose clamp.

In a first aspect of the present invention, there is provided a heavy-duty clamp for a hose, the clamp including a loop for disposing around the hose and having first and second axially spaced apart looped ends, the clamp comprises: a force generator, for drawing together the first and second looped ends, and connected to the first and second looped ends to apply a predetermined axial clamping force to the loop within a maximal axial clamping force rating of said clamp, the force generator including a bolt and a plurality of disc springs mounted thereon and made out of steel alloy material so as to allow said predetermined axial clamping force to be substantially high and constant under circumferential expansion and contraction of the hose over temperature operational condition thereof; a spacer member mounted on the force generator between the plurality of disc springs and the first looped end and axially transferring the clamping force from the force generator to the first and second looped ends, the clamping force axially drawing together the first and second looped ends so as to clamp the hose; and means for adjusting said maximal axial clamping force rating, said adjusting means including said plurality of disc springs being stacked against one another into one of a plurality of disc arrangements.

In one embodiment, the one of a plurality of disc arrangements includes said plurality of disc springs being arranged in series.

In another embodiment, the one of a plurality of disc arrangements includes said plurality of disc springs being arranged in parallel.

In a further embodiment, the one of a plurality of disc arrangements includes said plurality of disc springs being arranged in pairs of parallel disc springs, said pairs being arranged in series.

In one embodiment, each said disc spring has a conical shape configuration defined by a disc thickness and a disc conical angle, said adjusting means further including said plurality of disc spring being selectable from one of a plurality of disc configurations.

In one embodiment, the first looped end includes a first outer face and a first inner face, and the second looped end includes a second outer face and a second inner face, the first and second outer faces being angled inwardly towards each other and the first and second inner faces being curved and disposed inwardly towards each other. The first looped end includes first and second holes located in the respective first outer and inner faces and the second looped end includes third and fourth holes located in the respective second outer and inner faces, the holes being axially aligned with each other.

Typically, the bolt has a first bolt end and a second bolt end, and passes through the first, second, third and fourth holes. The bolt includes a threaded portion and a non-threaded portion, the non-threaded portion extending through and away from the first looped end. The plurality of disc springs and the spacer member are slidably mounted on the non-threaded portion, the plurality of disc springs being located near the first bolt end.

Typically, the force generator further includes a first capture nut mounted in the first looped end and a second capture nut mounted in the second looped end. The first capture nut includes a non-threaded axial bore. The second capture nut includes a threaded axial bore. The first and second capture nuts each includes a curved end and a stem portion.

Typically, the spacer member includes a cylindrical collar with an axial bore sized to accommodate the bolt therein, the cylindrical collar having a force receiver end and a force transfer end.

Typically, the stem portion of the first capture nut is disposed towards the first hole of the first looped end and abuts the force transfer end.

Typically, the second looped end includes one hole that is axially aligned with the first and second holes of the first looped end.

In one embodiment, the force generator is a T-bolt that passes though the first and second holes of the first looped end and through the one hole of the second looped end, the T-bolt having a T-bolt end and a threaded bolt portion on which is movably mounted a nut, the T-bolt end being located in the second looped end. The nut includes a smooth outer surface on which are mounted the disc springs and a threaded bore through which the T-bolt passes.

Typically, the second bolt end includes a nut stop. The nut stop is integral with the stem portion of the second capture nut.

Typically, the first hole of the first looped end is larger than the second hole of the first looped end.

Typically, the clamp loop, when viewed in cross section, includes a planar portion and two ends that are angled away from the surface of the hose.

Typically, a plate is hingeably connected to the first looped end is adapted to be in a circumferentially aligned relationship with the loop between the first and second loop ends when the clamp is disposed around the hose, thereby substantially clamping a section of the hose located between the first and second looped ends and bridging a gap therebetween.

Typically, the plate includes a guide portion for guiding the moveable first and second looped ends when moving towards and away from each other during clamping and under circumferential variation of the hose during operation thereof.

Typically, the plurality of disc springs are made out of corrosion resistant material.

Typically, the maximal axial clamping force rating of said clamp is within the range of about 100 in-lbs and about 420 in-lbs, preferably within the range of about 150 in-lbs and about 220 in-lbs.

Other objects and advantages of the present invention will become apparent from a careful reading of the detailed description provided herein, with appropriate reference to the accompanying drawings.

### BRIEF DESCRIPTION OF THE DRAWINGS

Further aspects and advantages of the present invention will become better understood with reference to the description in association with the following Figures, wherein:

FIG. 1 is a perspective view of an embodiment of a heavy-duty hose clamp of the present invention;

FIG. 1a is a cross section view taken along line 1a-1a of FIG. 1;

FIG. 2 is a side view of the hose clamp of FIG. 1;

FIG. 3a is a partial cutaway view of 10 series pairs of disc springs arranged in series and cooperating with a bolt of FIG. 1;

FIG. 3b is a perspective view of a spacer member;

FIG. 4a is a perspective view of a looped end;

FIG. 4b is a side view of a looped end with a capture nut located therein;

FIG. 5a is a side view of one capture nut;

FIG. 5b is an end view taken along line 5b of FIG. 5a;

FIG. 5c is a side view of a unitary capture nut/Stover nut;

FIG. 5d is a side view of a unitary capture nut/Nylon insert;

FIG. 6a is a side view of another capture nut;

FIG. 6b is an end view taken along line 6b of FIG. 6a;

FIGS. 7a to 7f are simplified section views of a number of disc springs illustrating different arrangements thereof;

FIG. 8 is a top view of a hingeable plate;

FIG. 9 is a side view of a second embodiment of the hose clamp;

FIG. 9a is a perspective view of a T-bolt engaged a looped end;

FIG. 9b is a side view of FIG. 9a;

FIG. 9c is a partial cutaway side view of a nut of FIG. 9;

FIG. 10 is a side view of a third embodiment of the hose clamp;

FIG. 11 is a side view of a fourth embodiment of the hose clamp;

FIG. 12 is a graphical representation of the internal hose pressure sustainable by a heavy duty clamp of the present invention and by a conventional coil spring clamp in function of the clamping torque applied thereon; and

FIG. 13 is a graphical representation of the spring deflection allowed by a heavy duty clamp of the present invention with different disc spring arrangements and by a conventional coil spring clamp in function of the clamping torque applied thereon.

### DETAILED DESCRIPTION OF THE PREFERRED EMBODIMENTS

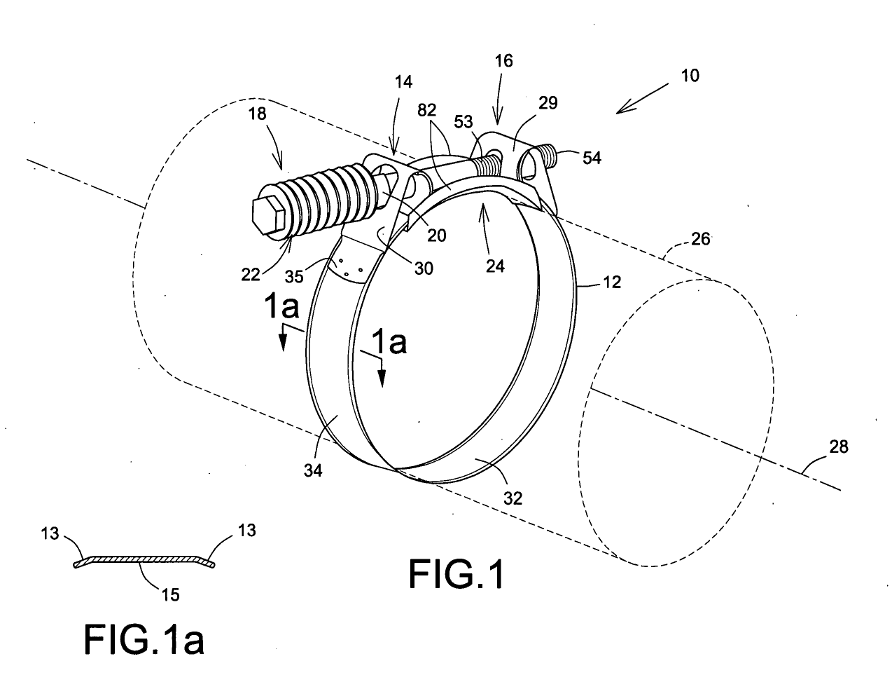

An embodiment of a hose clamp 10 of the present invention is shown in FIG. 1. Broadly speaking, the clamp 10 includes a clamp loop 12, two moveable looped ends 14 and 16, a force generator 18, a separator or spacer member 20, at least one and preferably a plurality of pairs of disc springs 22, and a hingeable plate 24; all typically made out of steel alloy material and preferably a corrosion resistant material such as stainless steel or the like.

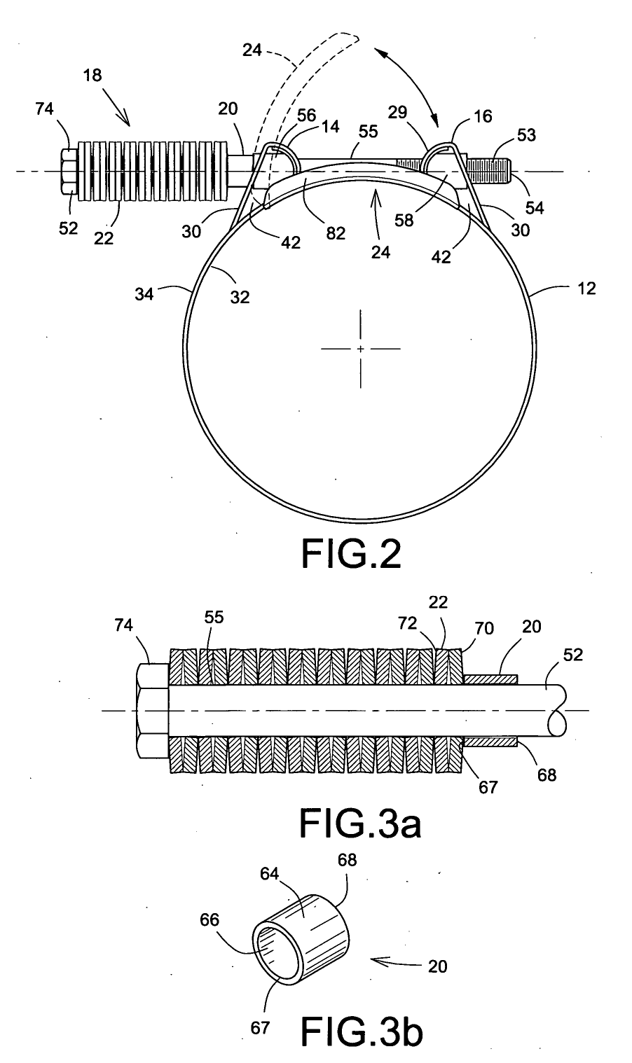

Referring now to FIGS. 1 and 2, in a typical application, an item for clamping, for example a high-pressure, heavy-duty hose 26 is received in the clamp loop 12. The clamp loop 12 is disposable axially along a main axis 28 of the hose 26 and annularly around the hose 26. The clamp loop 12 is typically made of stainless steel, which has sufficient resilience to withstand high operating torque forces applied thereto. The clamp loop 12 includes the two moveable looped ends 14 and 16, one of which will now be described in detail with reference to FIGS. 1 and 2. The looped end 14 has an inner face 29 and an outer face 30. The inner face 29 is continuous with an inner periphery surface 32 of the clamp loop 12. The outer face 30 is continuous with an outer periphery surface 34 of the clamp loop 12 and is angled inwardly. Typically, the clamp loop 12 is machined from a single piece of material, the ends of which are looped back on themselves and connected to the outer periphery surface 34 by a securing means 35 known to those skilled in the art. An example of such securing means include stamping, welding or staples and the like. In a default, non-clamping configuration, the inner faces 29 are axially spaced apart from each other and define a gap therebetween. The clamp loop 12 materials are sufficiently resilient to allow the moveable looped ends 14 and 16 to move towards each other, when subjected to clamping forces. In a clamping configuration, the hose 26 is clamped between the inner periphery surface 32 of the clamp loop 12 by the force generator 18 acting against the moveable looped ends 14 and 16.

As best illustrated in FIG. 1a, the clamp loop 12, in a clamping configuration when viewed in cross section, includes two ends 13 that are curved away from the hose 26 surface and a generally planar portion 15 which rests against the surface of the hose 26. The two curved ends 13 prevent the clamp loop 12 from biting into the hose 26 during clamping and reduce damage to the surface of the hose 26.

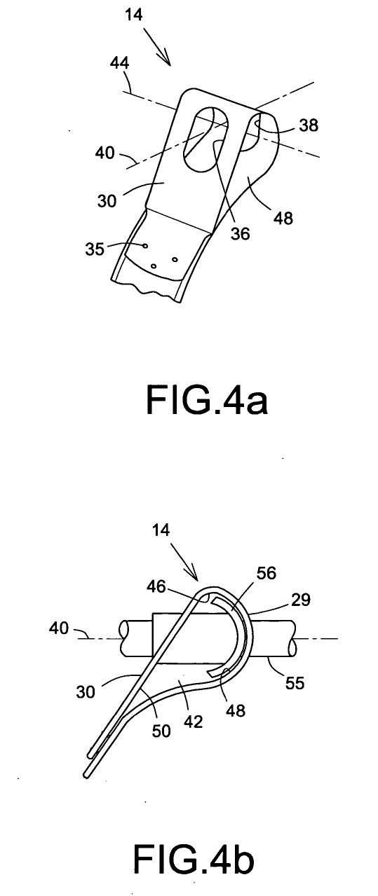

Referring now to FIGS. 4a and 4b, each of the looped ends 14 and 16 has two openings or holes 36 and 38 disposed therein. The holes 36 and 38 are axially aligned with each other and with the holes of the other moveable looped end. The holes 36 and 38 have an axis 40, which are aligned generally perpendicularly to the main axis 28 of the hose 26 during clamping. The hole 36 is disposed outwardly, whereas the hole 38 is disposed inwardly towards the gap. The hole 36 is generally of a larger size than hole 38 and is elliptical to allow the user to move the force generator 18 up and down to allow the force generator to be aligned with the hole 38. In addition, each of the looped ends 14 and 16 include a second opening 42, which has a second opening axis 44 that is generally perpendicular to the axis 40 and which is generally parallel to the main axis of the hose 26. The moveable looped ends 14 and 16 each have an inner surface 46 that defines the second opening 42. The inner surface 46 has a curved portion 48 and a generally planar portion 50. The curved portion 48 is disposed inwardly towards the other looped end and the gap there between.

Referring to FIGS. 2 and 3a, the force generator 18 passes through the holes 36 and 38 and cooperates with one of the outer faces 30 to apply an inwardly directed force thereto to draw the moveable looped ends 14 and 16 towards each other. In this embodiment, the force generator 18 is a bolt 52 that is sized to pass through each of the holes 36 and 38. The bolt 52 typically includes threads along a threaded portion 53 and a non-threaded smooth portion 55 on which the disc springs 22, that form a means for adjusting a displacement of the two looped ends 14, 16 relative to one another under the predetermined clamping force and under circumferential variation of the hose 26 over its operational condition range, are slidably mounted to allow for their smooth compression and expansion. The bolt 52 also includes a first bolt end 74 and a second bolt end 54.

Referring to FIGS. 2, 5a, 5b, 6a and 6b, the force generator 18 also includes two capture nuts 56 and 58 are positioned in the second openings 42. Both capture nuts 56 and 58 cooperate with the inner surface of the looped ends 14, 16 to generate the inwardly directed forces thereon. The capture nut 56 has a non-threaded axial bore 57, whereas the capture nut 58 has a threaded axial bore 59, both bores 57 and 59 are sized to allow engagement with the bolt 52. The bolt 52, in the clamping configuration extends through each of the bores 57 and 59, the end 54 of the threaded bolt extends outwardly from capture nut 58. Both capture nuts 56 and 58 include a curved end portion 60 and a stem portion 62. The curved end portion 60 cooperates with the curved portion 48 of the looped end 14, 16 and is disposed towards the gap. The stem portion 62 is disposed towards the planar portion 50 of the looped ends 14, 16. The stem 62 of the capture nut 56, located in the looped end 14, is cooperable with the spacer 20 to receive the inwardly directed force thereagainst. Both capture nuts 56 and 58 have elongate sides 61 and a shorter side 63. Recesses 65 extends inwardly from the shorter side 63 of the capture nut 56 to allow access room to the pins 76 of the hingeable plate 24 for the pivoting thereof, as further explained hereinbelow.

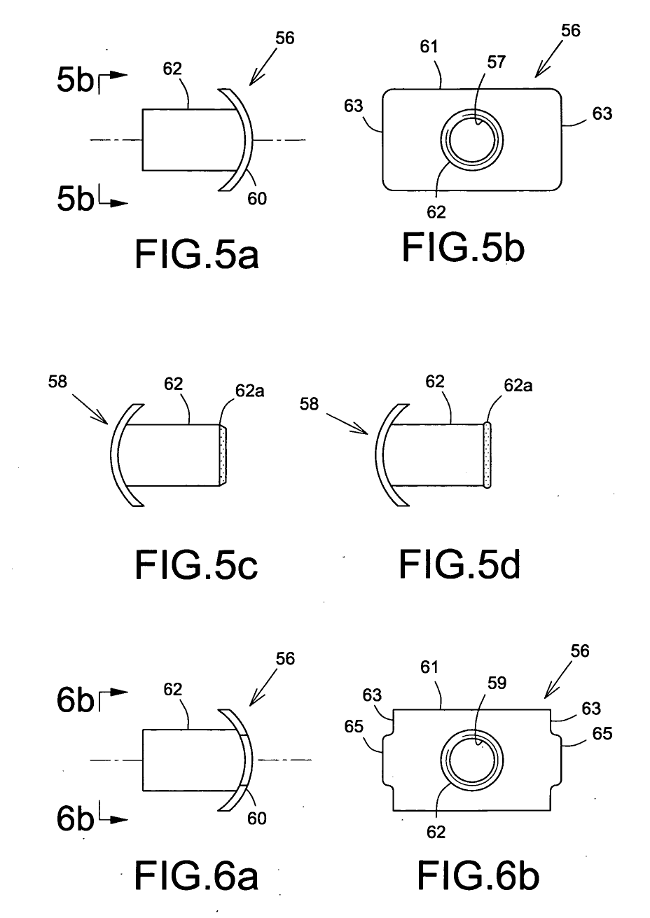

As shown in FIGS. 5c and 5d, a friction nut stop 62a in the form of a Stover nut or a nylon insert nut, respectively, or an abutting nut stop as a lock nut (not shown) may be added to the bolt end 54 after torquing to damp against major vibrations, and rests against the stem 62 of the capture nut 58. Alternatively, the capture nut 58 and the nut stop 62a may be a unitary piece 58a, in which the nut stop 62a, Stover nut and nylon insert nut, are integral with the stem 62.

Referring to FIGS. 2, 3a, and 3b, the spacer member 20 of the present invention is axially aligned with the holes 36 and 38 in the looped ends 14, 16. The spacer member 20 is orientated towards the outer face of the looped end 14 to axially transfer the inwardly directed force from the bolt 52 to move the moveable looped ends 14, 16 together. The spacer member 20 is a cylindrical collar 64 with an axial bore 66 of sufficient size to slide over a non-threaded portion of the threaded bolt 52. The cylinder 64 has a force receiver end 67 and a force transfer end 68. The force receiver end 67 abuts a first generally convex outer face 70 of one of the disc springs 22. The force transfer end 68 abuts the stem portion 62 of the capture 56. Both the ends 67 and 68 have planar surfaces for contacting the stem 62 and the first face 70 of the disc spring 22.

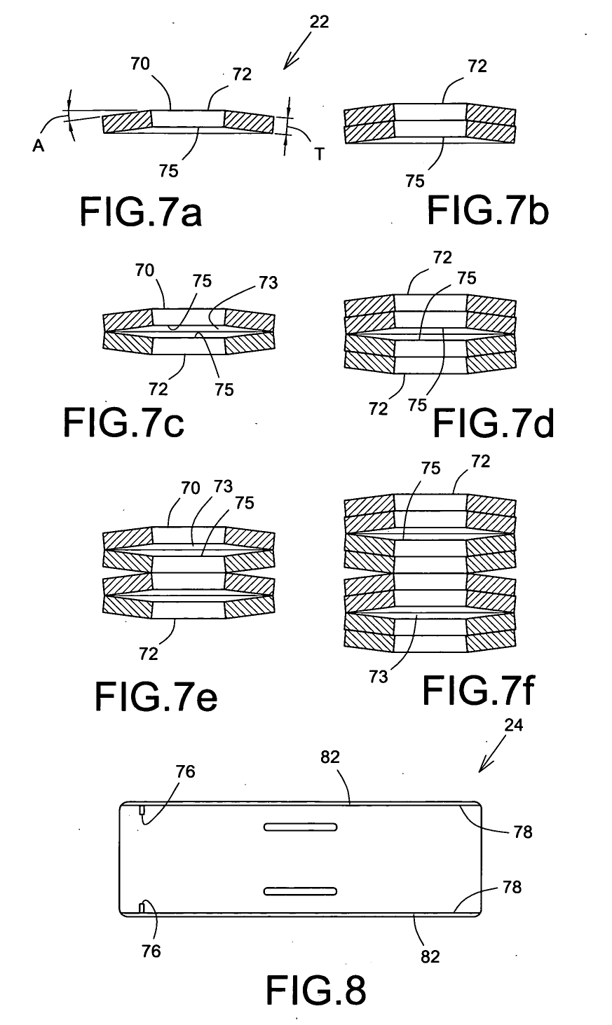

Each disc spring 22 essentially has a conical shape configuration defined by a disc thickness T and a disc conical angle A, as shown in a rest state in FIG. 7a, which determines the required maximal axial compressive force to fully compress the spring 22 in a flattened and fully deflected state (not shown). When stacked against one another into a disc arrangement, a plurality of disc springs 22 require an overall maximal axial compressive force to fully deflect the disc arrangement and providing a corresponding overall deflection, depending on the disc arrangement. Accordingly, the clamp 10 of the present invention includes a means for adjusting the maximal axial clamping force rating thereof by the selection of one from a plurality of possible disc arrangements. The selection of the disc shape configuration of the disc springs 22 forming the disc arrangement is also part of the adjusting means. For a same conical angle A and disc inner and outer diameters, the larger the disc thickness T is the larger the required maximal axial compressive force rating is.

Now referring to FIGS. 7a to 7f, there are shown different disc arrangements. In FIG. 7a, the disc spring 22 has a predetermined maximal deflection when subjected to its maximal axial compressive force. The series disc arrangements of FIGS. 7c and 7e of two and four disc springs 22 require the same maximal axial compressive force to fully compress or flatten the disc arrangements, while the maximal deflections of the arrangements would substantially be two and four times the maximal deflection of the single disc spring 22 of FIG. 7a, respectively.

Similarly, the series disc arrangements of FIGS. 7b, 7d and 7f of two, four and eight disc springs in pairs of parallel disc springs (two-by-two in parallel) require about twice the maximal axial compressive force of the single disc spring 22 to fully compress or flatten the disc arrangements (because of the pairs of parallel disc springs), while the maximal deflections of the arrangements would substantially be one, two and four times the maximal deflection of the single disc spring 22 of FIG. 7a, respectively.

Referring to FIGS. 3a and 7a to 7f, one can understand that with the disc springs 22 axially aligned and stacked against one another with the spacer member 20 and the bolt 52 to transfer the inwardly directed clamping force to the moveable looped ends 14, 16, many possible maximal clamping loads can be achieve depending on the disc configuration and disc arrangement thereof.

In the embodiment shown in FIGS. 1, 2 and 3a, a number of the disc springs 22 are arranged in a series arrangement in pairs along the non-threaded portion of the bolt 52. When a selected number of N (20 disc springs shown in FIGS. 1, 2 and 3a) disc springs 22 are arranged in series, the maximal axial clamping torque force required to flatten (to render flat) all disc springs is the same as the one required to flatten a single disc spring, with an overall compressive deflection being approximately N times the one obtained with a single disc spring 22. Each pair of the disc springs 22 includes the first face 70, an opposite second face 72 and a central space 73 defined by generally concave inner faces 75. The second face 72 cooperates with the bolt end head 74 to receive the clamping force thereagainst. When fully deflected, the central space 73 becomes substantially inexistent or null since the opposed second faces 72 touch one another.

From the above, the disc springs 22 can be used in many different arrangements (as shown in FIGS. 7a to 7f) and have sufficient resilience to contract against each other when forces are applied to one or both faces 70 and 72. One skilled in the art will recognize that one disc spring 22 may be used with the bolt 52 such that either of the first or second faces 70, 72 and the inner face 75 receives the clamping force from the bolt end head 74.

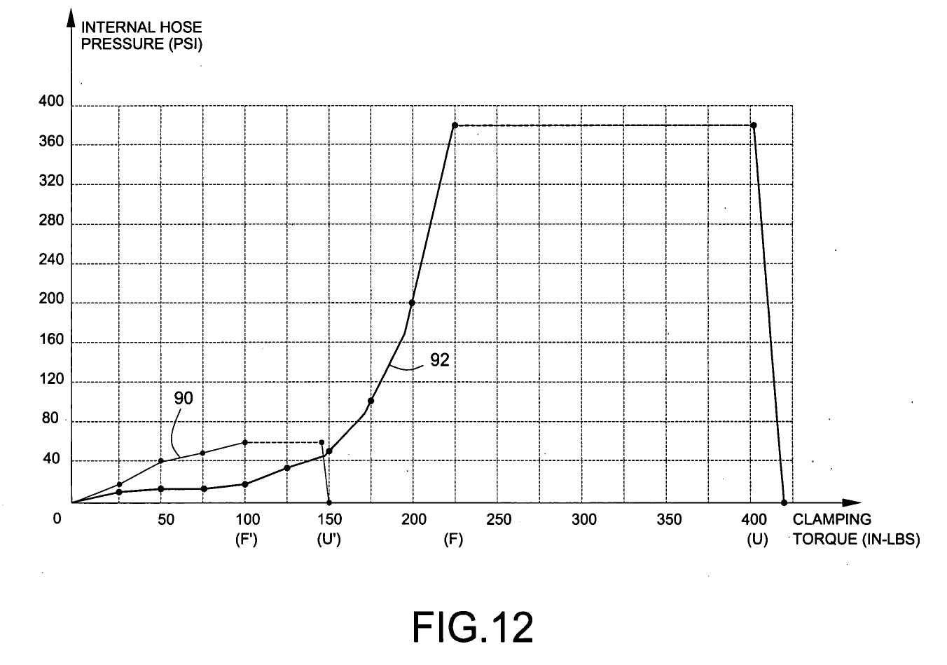

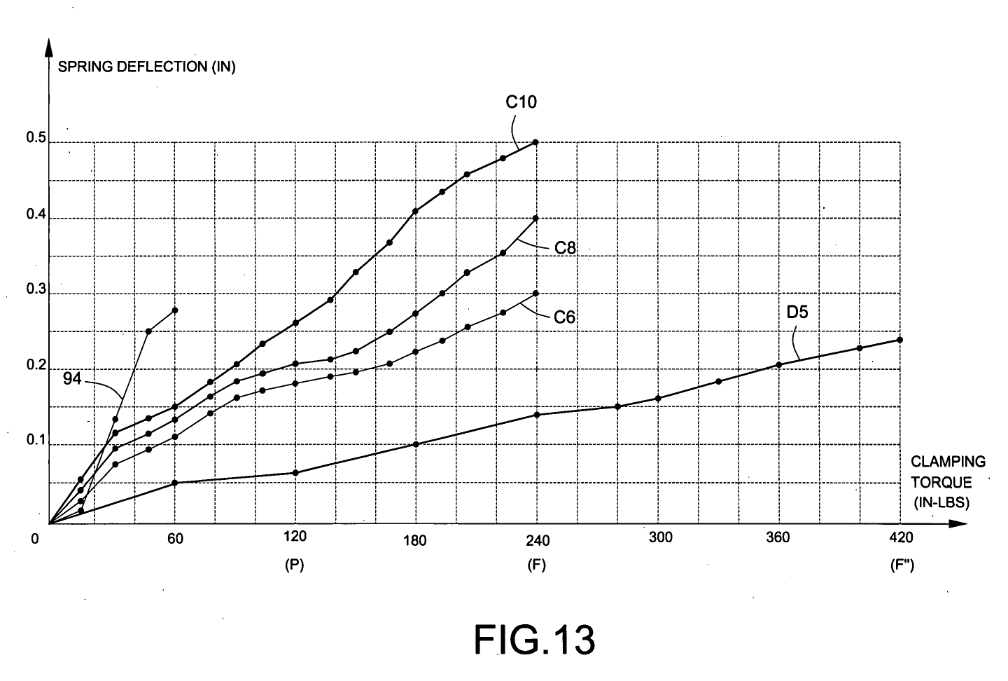

As shown in FIG. 12, there is shown in curve 92 (same arrangement as for curve C8 of FIG. 13), for a typical heavy-duty clamp of the present invention similar to the one shown in FIGS. 1 and 2 but with eight (8) pairs of single disc springs 22, the hose internal pressure that is safely sustainable by the clamp as a function of the clamping torque force applied thereto to secure the hose 26. For example, with a securing applied clamping torque force of about 200 in-lbs, the clamp will sustain a hose internal pressure up to about 200 psi. The beginning of the flat portion of the curve provide the maximal clamping torque rating F at which the disc arrangement is fully deflected, while the end thereof shows the ultimate clamping torque force U at which the clamp breaks apart or fails. Curve 90 explicitly shows the same torque limitations F′, U′ of a conventional coil spring clamp, which are well bellow the ones of the present clamp 10. In fact, it would not be practically feasible to obtain the same clamping torque range as for the disc spring clamp 10 of the present invention with the conventional coil spring clamp unless the coil spring increases to a few inches in diameter.

Typically, as illustrated by an actual tested example of FIG. 12, conventional hose clamps have an ultimate clamping torque rating U′ (at clamp failure) of about 150 in-lbs torque working force with a workable maximal clamping torque rating F′ (at full deflection or compression of coil spring) of about 100 in-lbs (as illustrated with curve 90 of FIG. 12), whereas with the hose clamp 10 of the present invention, this ultimate clamping torque rating U increases significantly up to about 420 in-lbs with a workable maximal clamping torque rating F of about 220 in-lbs (as illustrated with curve 92 of FIG. 12). At clamping torque values of less than 100 in-lbs, the clamp of the present invention (curve 92) is slightly less efficient than the conventional coil spring clamp simply because of the wider loop 12 providing less pressure by square inch at the loop-hose contact interface; the wider loop being required to enable the higher efficient clamping torque range of the heavy-duty clamp 10.

When clamping a hose 26 with the clamp 10 of the present invention, one can select the predetermined clamping force to use based on the requirements and the operational condition of the hose and the clamp, namely temperature and humidity operational ranges over time. Accordingly, for a same clamping force or torque, the more bolt linear displacement variation (spring deflection) and therefore circumferential variation of the hose will be allowed under operational condition when more disc springs are used, as seen from curves C6, C8 and C10 of FIG. 13 representing 6, 8 and 10 single (or series) pairs of disc springs in series, respectively (C8 being 4 times the arrangement shown in FIG. 7e, C10 being the arrangement shown in FIG. 2). Hence, by varying the quantity of disc springs, the linear displacement of the two looped ends 14, 16 during the hose circumferential variation can be adjusted, and the slightly varying clamping force controlled. Curve D5 represents a clamp 10 with a disc arrangement of five (5) pairs of double disc springs 22 in series (5 times the arrangement shown in FIG. 7d). Although this latter arrangement includes the same quantity of disc springs as the C10 curve, its clamping torque rating F″ is about twice that (F) of C10 (because of double or parallel disc springs), 420 in-lbs viz 220 in-lbs, with half the overall maximal deflection (because of five (5) pairs instead of ten (10) for C10).

In the case in which the disc arrangement would include a mix of single disc pairs and double disc pairs in series, its behavior of would provide a larger deflection rate (more deflection per unit change of clamping torque) at the low torque end of the curve than the same end of the corresponding curve representing an arrangement with only double disc pairs in series, while the end of both curves would have an essentially similar deflection rate relative to one another since all the single disc pairs would have already been fully deflected in that portion of the curve.

More specifically, when the hose 26, after clamping with a predetermined clamping force P (which could be anywhere along the torque axis of FIG. 13), expands outwardly such as during operations when the hose 26 carries high temperature, high pressure fluids such as water, steam, or oil, the outward expansion forces act against the inner periphery surface 32 of the clamp loop 12 and act against the inwardly directed clamping force P to maintain a substantially constant clamping force. The hose expansion will make the clamping torque to slightly increase, as illustrated when moving toward the right hand side on any curve C6, C8 or C10 from the force P of FIG. 13. The disc springs 20 have sufficient resilience to deform during the expansion such that the size of the central space 73 decreases thereby taking up the increase in the inwardly directed force of the force generator 18 to compensate for the expansion of the hose 26 and the increasing distance between the two looped ends 14, 16.

Similarly, as the hose 26 cools, it will contract and the central space 73 of the disc springs 22 will increase in size to compensate for the decreasing distance between the two looped ends 14, 16, the disc springs 22 attaining their dish-like appearance and the force generator 18 will retain its substantially constant predetermined clamping force P against the disc springs 22 and against the hose 26; as illustrated when moving toward the left hand side on any curve C6, C8 or C10 from the force P of FIG. 13. Curve 94 of FIG. 13 shows the spring deflection of a conventional coil spring clamp at its relatively low clamping torques.

Referring to FIGS. 1, 2 and 8, the hingeable plate 24 is hingeably connected to one of the looped ends 14. The plate 24 is continuous, or circumferentially aligned, with the inner clamp loop periphery 32 and includes two inward projections 76. The plate 24 may also include a single bar in place of the two projections 76, which may be positioned across the plate to lock the plate 24 in place during clamping. The hingeable plate 24 acts as a bridge across the gap and includes a guide portion 78 located on an outer face 80 for guiding the moveable looped ends 14 and 16 along a path of travel towards and away from each other during clamping. The guide portion 78 includes two opposing edge walls 82 axially aligned with the openings 36 and 38. The plate 24 allows the user a means by which the looped ends 14 and 16 can be aligned and allows maneuverability of the clamp 10 along the hose 26 before clamping. The plate 24 may optionally be swung out of alignment (as shown in outline in FIG. 2) with the looped ends 14 and 16 should the user need to completely disengage the hose clamp 10 from the hose 26.

Operation

Referring to FIGS. 1 and 2, generally, the hose clamp 10 is supplied in a default configuration with the bolt 52 disconnected from the looped ends 16 and 18 and the capture nuts 56 and 58. Considering the initial torque P that is required and the torque variation that is acceptable for an expected amount of circumferential variation (contraction/expansion) of the hose over its operational condition over time, the user selects the appropriate number of disc springs 22 and adds them to the shaft of the bolt 52 and slides the spacer member 20 onto the bolt 52 shaft. The bolt 52 is positioned adjacent the non-threaded bore 57 of the capture nut 56 and with the hose 26 to be clamped in place snuggly against the inner periphery 32, the operator aligns the bolt end 54 with the hole 38 and the threaded bore 59 of the capture nut 58. The user then applies a turning force to the bolt end 74 causing the moveable ends 14 and 16 to slide along the plate 24 towards each other thereby tightening the clamp 10 around the hose 26 to the required torque. Alternatively, the clamp 10, with the disc springs 22, the spacer member 20 and capture nuts 56 and 58 aligned, is slipped over the hose 26, which is connected to a fluid source (not shown). The clamp 10 is then tightened as described.

Alternatives

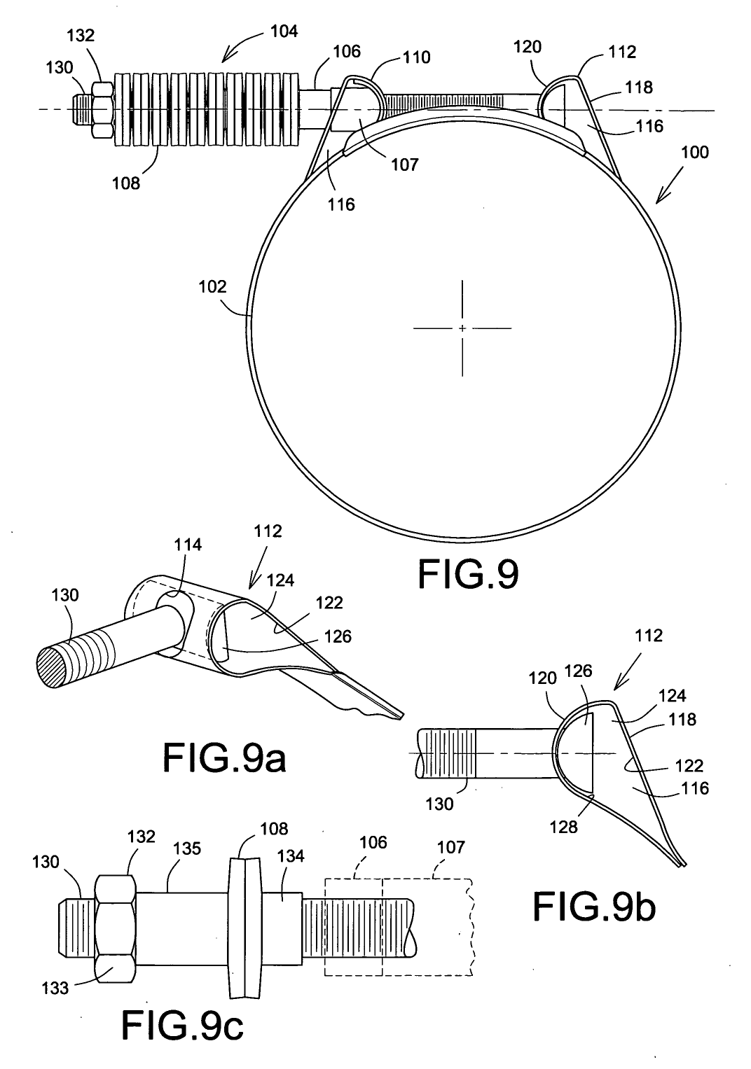

The first embodiment of the hose clamp 10 is useful in many clamping operations. There may be applications, such as for hoses in areas of limited accessibility that require the use of a T-bolt in combination with the disc springs, the spacer member and a hingeable plate which has limited movement. A second embodiment 100, illustrated in FIG. 9, operates in essentially the same way as the first embodiment 10 and includes a clamp loop 102, a force generator 104, a spacer member 106, a capture nut 107, disc springs 108, and two moveable looped ends 110 and 112. The differences between 10 and 100 will now be described with reference to FIGS. 9a, 9b and 9c.

The looped end 112 includes a hole 114, an opening 116, a generally planar outward face 118 and a curved inward face 120. A shaped inner surface 122 defines the second opening 116, a planar portion 124 of which lies adjacent a T-bolt end 126. During clamping, the T-bolt end 126 pushes against a curved surface 128 of the second opening 116 and inwardly transfers the clamping force as the force generator 104 acts inwardly against the looped end 110, as described for the clamp 10. The force generator 104 includes an elongated threaded bolt portion 130 and a nut 132 mounted on the bolt threads.

As best illustrated in FIG. 9c, the nut 132 has a smooth outer surface 134, on which the disc springs 108 (only two are shown) are mounted for sliding and abutment against the spacer member 106, and a threaded bore (not shown) through which the bolt 130 passes during clamping. Unlike with the clamp 10, turning the bolt 130 causes the disc springs 108 to move along the smooth surface 134 of the nut 132 towards the spacer member 106, while the nut 132 moves down the bolt 130 shaft. The nut 132 may alternatively include a nut head 133 that is separate from a smooth surfaced sleeve 135 and still work the same way as the unitary nut 132.

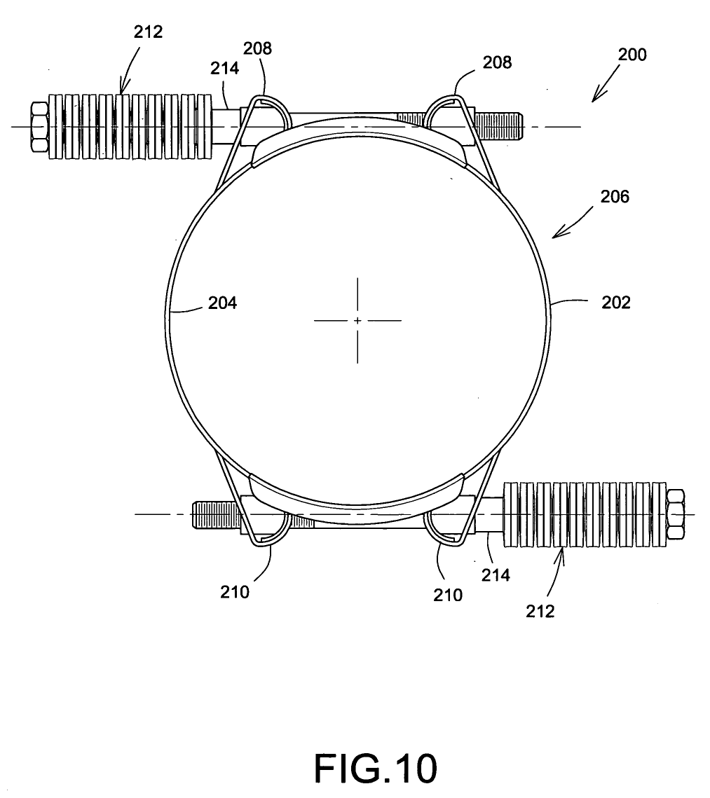

A third embodiment of a hose clamp 200 is illustrated in FIG. 10 and operates in the same way as the first embodiment of the hose clamp 10. There may be clamping applications that require the use of a hose clamp loop that has two gaps between two sets of movable looped ends. The hose clamp 200 includes first and second clamp portions 202 and 204, which together form a clamp loop 206. Two sets of moveable looped ends 208 and 210 are moveable by two force generators 212 with two spacer members 214.

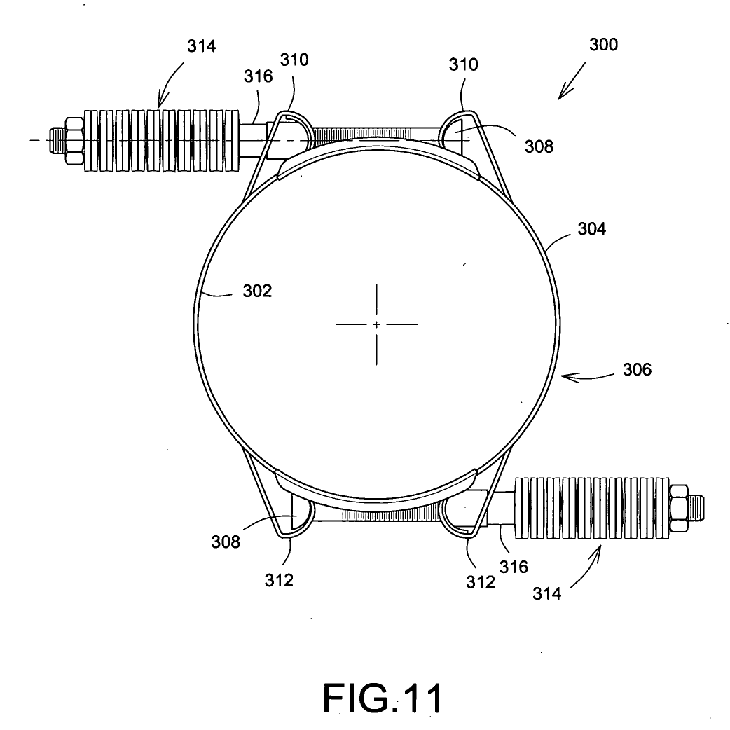

A fourth embodiment of a hose clamp 300 is illustrated in FIG. 11 and is structurally similar to the second embodiment 200. The hose clamp 300 includes first and second clamping portions 302 and 304, which together form a clamp loop 306. Two T-bolts 308 are used together with two sets of moveable looped ends 310 and 312, which are moveable by two force generators 314 with two spacer members 316.

While a specific embodiment has been described, those skilled in the art will recognize many alterations that could be made within the spirit of the invention, which is defined solely according to the following claims.

I claim:

1. A heavy-duty clamp for a hose, the clamp including a loop for disposing around the hose and having first and second axially spaced apart looped ends, the clamp comprising:
a force generator, for drawing together the first and second looped ends, and connected to the first and second looped ends to apply a predetermined axial clamping force to the loop within a maximal axial clamping force rating of said clamp, the force generator including a bolt and a plurality of disc springs mounted thereon and made out of steel alloy material so as to allow said predetermined axial clamping force to be substantially high and constant under circumferential expansion and contraction of the hose over temperature operational condition thereof;
a spacer member mounted on the force generator between the plurality of disc springs and the first looped end and axially transferring the clamping force from the force generator to the first and second looped ends, the clamping force axially drawing together the first and second looped ends so as to clamp the hose; and
means for adjusting said maximal axial clamping force rating, said adjusting means including said plurality of disc springs being stacked against one another into one of a plurality of disc arrangements.

2. The clamp, according to claim 1, wherein said one of a plurality of disc arrangements includes said plurality of disc springs being arranged in series.

3. The clamp, according to claim 1, wherein said one of a plurality of disc arrangements includes said plurality of disc springs being arranged in parallel.

4. The clamp, according to claim 1, wherein said one of a plurality of disc arrangements includes said plurality of disc springs being arranged in pairs of parallel disc springs, said pairs being arranged in series.

5. The clamp, according to claim 1, wherein each said disc spring has a conical shape configuration defined by a disc thickness and a disc conical angle, said adjusting means further including said plurality of disc spring being selectable from one of a plurality of disc configurations.

6. The clamp, according to claim 1, in which the first looped end includes a first outer face and a first inner face, and the second looped end includes a second outer face and a second inner face, the first and second outer faces being angled inwardly towards each other and the first and second inner faces being curved and disposed inwardly towards each other.

7. The clamp, according to claim 6, in which the first looped end includes first and second holes located in the respective first outer and inner faces and the second looped end includes third and fourth holes located in the respective second outer and inner faces, the holes being axially aligned with each other.

8. The clamp, according to claim 7, in which the bolt has a first bolt end and a second bolt end, the bolt passing through the first, second, third and fourth holes.

9. The clamp, according to claim 8, in which the bolt includes a threaded portion and a non-threaded portion, the non-threaded portion extending through and away from the first looped end, the plurality of disc springs and the spacer member are slidably mounted on the non-threaded portion, adjacent the first bolt end.

10. The clamp, according to claim 9, in which the force generator further includes a first capture nut with a non-threaded axial bore mounted in the first looped end and a second capture nut with a threaded axial bore mounted in the second looped end.

11. The clamp, according to claim 10, in which the spacer member includes a cylindrical collar with an axial bore sized to accommodate the bolt therein, the cylindrical collar having a force receiver end and a force transfer end.

12. The clamp, according to claim 11, in which the first and second capture nuts each includes a curved end and a stem portion, the stem portion of the first capture nut being disposed towards the first hole of the first looped end and abuts the force transfer end.

13. The clamp, according to claim 7, in which the second looped end includes one hole that is axially aligned with the first and second holes of the first looped end.

14. The clamp, according to claim 13, in which the force generator is a T-bolt that passes though the first and second holes of the first looped end and through the one hole of the second looped end, the T-bolt having a T-bolt end and a threaded bolt portion on which is movably mounted a nut, the T-bolt end being located in the second looped end.

15. The clamp, according to claim 14, in which the nut includes a smooth outer surface on which are mounted the plurality of disc springs and a threaded bore through which the T-bolt passes.

16. The clamp, according to claim 12, in which the second bolt end includes a nut stop.

17. The clamp, according to claim 16, in which the nut stop is integral with the stem portion of the second capture nut.

18. The clamp, according to claim 6, in which the first hole of the first looped end is larger than the second hole of the first looped end.

19. The clamp, according to claim 1, in which the clamp loop, when viewed in cross section, includes a planar portion and two ends that are angled away from the surface of the hose.

20. The clamp, according to claim 1, in which a plate is hingeably connected to the first looped end is adapted to be in a circumferentially aligned relationship with the loop between the first and second loop ends when the clamp is disposed around the hose, thereby substantially clamping a section of the hose located between the first and second looped ends and bridging a gap therebetween.

21. The clamp, according to claim 20, in which the plate includes a guide portion for guiding the moveable first and second looped ends when moving towards and away from each other during clamping and under circumferential variation of the hose during operation thereof.

22. The clamp, according to claim 1, in which the plurality of disc springs are made out of corrosion resistant material.

23. The clamp, according to claim 1, in which the maximal axial clamping force rating of said clamp is within the range of about 100 in-lbs and about 420 in-lbs.

24. The clamp, according to claim 23, in which the maximal axial clamping force rating of said clamp is within the range of about 150 in-lbs and about 220 in-lbs.
